(19) United States
(12) Patent Application Publication
(10) Pub. No.: US 2014/0278911 A1
(43) Pub. Date: Sep. 18, 2014

(54) METHOD AND APPARATUS FOR DETERMINING DIGITAL MEDIA AUDIBILITY

(71) Applicant: TELEMETRY LIMITED, (US)

(72) Inventors: Geo CARNCROSS, Ealing (GB); Beau CHESLUK, London (GB); Anthony RUSHTON, West Byfleet (GB); Russell IRWIN, London (GB); Adam LUSTED, London (GB); Daniel MORSE, London (GB); Paul FREEMAN, London (GB); Maximillian MURPHY, London (GB); Robert STEWARD, London (GB)

(73) Assignee: TELEMETRY LIMITED, London (GB)

(21) Appl. No.: 13/840,617

(22) Filed: Mar. 15, 2013

(51) Int. Cl. G06Q 30/02

(52) U.S. Cl. CPC G06Q 30/0242
USPC 705/14.41

(57) ABSTRACT

A method of determining the audio level of a network partner media player, wherein, when media playing on a terminal media player running on a terminal originates from an external media source, the method comprises obtaining activity information from the terminal, obtaining activity information from the terminal media player, obtaining activity information from an external source media player associated with the external media source, and analysing the activity information from the terminal, the activity information from the terminal media player, the activity information from the external media source media player, whereby the audio level of the network partner media player is determined.

### TECHNICAL FIELD

The present invention relates to methods and apparatus for determining the audibility of media on a web page shown within a web browser.

### BACKGROUND OF THE INVENTION

As a result of the increase in the number of computing devices available to users, the proportion of media viewed and/or heard by the public through an internet connection has increased. It is expected in the coming years that this proportion will increase further so that a significant proportion of the media viewed and/or heard by users will be viewed on electronic devices such as laptops, netbooks, tablets and mobile phones through interfaces such as web browsers.

The introduction of Personal Video Recorders (PVRs), Digital Set-Top Boxes and Digital radios in recent years has decreased the effectiveness of advertisements within such traditional areas as television and/or radio “ad-breaks”. The placement of advertisements to capture the emerging mechanisms for viewing and listening to media has therefore been a subject of interest within the advertising industry in recent years.

In particular, digital video and/or audio advertising is increasingly used. An advertiser or advertising agency will create media, typically in the form of an advertisement, i.e. a digital video and/or digital audio. The advertisement is distributed by a publisher who delivers the digital video and/or audio content to positions within web pages to be viewed and/or heard by a user. It is common for an advertiser to pay the publisher per instance of the digital video and/or audio content delivered, in other terms per “impression” or “placement”. However, in order for the advertiser to be confident that they are receiving value for money it is important that the digital video and/or audio content is provided to the viewer and/or listener in a way that enables the viewer and/or listener to view and/or listen to the media, for example in the form of visible and/or audible digital video and/or audio content.

It is important for an advertiser or advertising agency to determine whether the audio content associated with a digital video media or standalone digital audio media, here termed generically as “digital audio media”, was audible, that is, that it could be heard. If a digital audio media was not audible, it is important for the advertiser or advertising agency to understand if the listener turned the volume down or the media did not have the opportunity of being heard, through for example an audio level being muted or set to a low level.

It is important to determine if a user has “bounced” a web page, away from an audio advertisement. Further, it is important to determine if unscrupulous publishers and ad networks individually or in cooperation mute or reduce the sound level relating to an audio placement to avoid or reduce such bouncing.

In order to ascertain the effectiveness, and therefore the value, of an advertising campaign or individual advertisement directed to digital audio media obtained through an internet connection, suitable metrics are required. Such metrics may include an indication of whether media, such as an advertisement, was audible to the listener and how much of the media was audible for that impression or placement.

It is not currently possible to obtain metrics for a large census of a particular advertising campaign utilising digital audio media because, for a particular placement or impression presented to a listener, there are potentially multiple controls relating to the digital audio level. For example, the computing device may have an audio level. In addition the contract between a publisher and advertiser may utilise a network partner of the publisher, operating between the publisher and advertiser, where there may be audio controls associated with the publisher, the network partner and the advertiser.

### SUMMARY

In a first aspect, the invention provides a method of determining the audio level of a network partner media player, wherein; when media playing on a terminal media player running on a terminal originates from an external media source, the method comprises: obtaining activity information from the terminal; obtaining activity information from the terminal media player; obtaining activity information from an external source media player associated with the external media source; and analysing: the activity information from the terminal; the activity information from the terminal media player; the activity information from the external media source media player, whereby the audio level of the network partner media player is determined.

Preferably, the terminal media player runs on a web page in a web browser on the terminal.

Preferably, the external media source is an advertiing server.

Preferably, the activity information from the terminal comprises a determined sound level.

Preferably, the activity information from the terminal comprises the terminal volume setting.

Preferably, the activity information from the terminal media player comprises the audio level of the terminal media player.

Preferably, the terminal media player is polled to determine the audio level.

Preferably, the terminal media player comprises Flash™/Actionscript.

Preferably, the polling comprises using global mixer volume.

Preferably, the terminal media player comprises a HTML5 <video> element.

Preferably, the terminal media player comprises a HTML5 <audio> element.

Preferably, polling comprises using a Javascript Video Tag Element.

Preferably, the activity information of the terminal media player comprises information relating to the frequency spectrum of audio output from the terminal media player.

Preferably, information relating to the frequency spectrum of audio output from the terminal media player comprises determining the audio amplitude at different frequencies of the frequency spectrum.

Preferably, the method further comprises combining the audio amplitude at different frequencies.

Preferably, determining the audio amplitude at different frequencies comprises determining an inverse of a transformed frequency spectrum.

Preferably, the activity information of the external media source media player comprises the audio level.

Preferably, the external media source media player is polled to determine the audio level.

Preferably, the external media source media player comprises Flash™/Actionscript.

Preferably, the polling comprises using global mixer volume.

Preferably, the terminal media player comprises a HTML5 <video> element.

Preferably, the user media player comprises a HTML5 <audio> element.

Preferably, the polling comprises using a Javascript Video Tag Element.

Preferably, the sound level is determined using sound monitoring equipment.

Preferably: the activity information from the terminal comprises information relating to the terminal volume setting; the activity information from the terminal media player comprises the audio level of the terminal media player; the activity information of the terminal media player comprises the audio output from the terminal media player; the activity information of the external media source media player comprises the audio level; and analysing the activity information from the terminal, the activity information from the terminal media player, and the activity information from the external media source media player comprises combining any two or more of: the terminal volume setting; the audio level of the terminal media player; the audio output from the terminal media player; and the audio level of the external media source media player, wherein the resultant value is taken from the determined sound level from the terminal.

Preferably, the combining comprises multiplication.

Preferably, the combining comprises convolution.

Preferably, the combining comprises addition.

Preferably, taking the resultant value from the determined sound level comprises division.

Preferably, taking the resultant value from the determined sound level comprises de-convolution.

Preferably, taking the resultant value from the determined sound level comprises subtraction.

Preferably, the media is digital media.

Preferably, the media is digital audio media.

Preferably, the media is an advertisement.

In a second aspect, the invention provides computer apparatus arranged to determine the volume output of a network partner media player, the apparatus comprising: an interface configured to receive activity information from code running on the terminal; and computer code operable, when executed, to carry out the method of the first aspect.

In a third aspect, the invention provides a method of determining whether media playing on a terminal media player running on a terminal is audible, wherein the media originates from an external media source, the method comprising: monitoring and analysing activity information associated with media when playing on the terminal to determine whether the media is audible.

Preferably, the terminal media player runs on a web page in a web browser on the terminal.

Preferably, the external media source is an advertising server and the media is advertising.

Preferably, activity information associated with media when playing on the terminal comprises information relating to the terminal volume setting.

Preferably, the activity information associated with media when playing on the terminal comprises information relating to the activity of the terminal media player.

Preferably, the terminal media player calls and runs a media player associated with the external media source.

Preferably, the activity information associated with media when playing on the terminal comprises information relating to the activity of the external media source media player.

Preferably, the media originating from the external media source is provided to the terminal via a network partner.

Preferably, the terminal media player calls and runs a network partner media player, wherein the network partner media player calls and runs the external media source media player.

Preferably, the activity information associated with media when playing on the terminal comprises information relating to the activity of the network partner media player.

Preferably, the obtained activity information is input into a model; and wherein the model provides an estimation of whether the media is audible based upon the input activity information.

Preferably, the model is a numerical model.

Preferably, the numerical model comprises a probabilistic model.

Preferably, the numerical model comprises a regression analysis.

Preferably, the coefficients of the numerical model are determined using training activity information.

Preferably, the activity of the terminal media player comprises the audio level of the terminal media player.

Preferably, the information relating to the activity of the terminal media player comprises information relating to the frequency spectrum of audio output from the terminal media player.

Preferably, information relating to the frequency spectrum of audio output from the terminal media player comprises determining the audio amplitude at different frequencies of the frequency spectrum.

Preferably, the method comprises combining the audio amplitude at different frequencies.

Preferably, the method comprises determining an inverse of a transformed frequency spectrum.

Preferably, the activity of the external media source media player comprises the audio level.

Preferably, the media player is polled to determine the audio level.

Preferably, the media player comprises Flash/Actionscript.

Preferably, polling comprises using global mixer volume.

Preferably, the media player comprises a HTML5 <video> element.

Preferably, the media player comprises a HTML5 <audio> element.

Preferably, polling comprises using a Javascript Video Tag Element.

Preferably, activity information from the user terminal comprises a determined sound level.

Preferably, the sound level is determined using sound monitoring equipment.

Preferably, the activity of the network partner media player comprises the volume output of the network partner media player determined using the method of the first aspect.

Preferably, the media is digital media.

Preferably, the media is digital audio media.

Preferably, the media is an advertisement.

In a fourth aspect, the invention provides computer apparatus arranged to determine the volume associated with media playing on a web page in a web browser on a user terminal, the apparatus comprising: an interface configured to receive activity information from code running on the user terminal; computer code operable, when executed, to carry out the method of the third aspect.

The capability to detect whether media is audible within a web page across a large number and variety of terminals may be used in a number of different applications, including fraud detection, auto-instantiated placements, reach estimation, and to give publishers and/or advertisers greater strength in instantiating media as a specific product.

Media may be considered as one of a number of different types including rich media (non-video), and digital audio content including interactive video and/or audio. Media may also encompass videos or audio media in the form of advertisements or in other forms.

An impression or placement is a term used in this context for a single instance of the media content being made available to an end user.

### BRIEF DESCRIPTION OF THE DRAWINGS

The invention is diagrammatically illustrated by way of example, in the accompanying drawings in which:

FIG. 1 shows a schematic overview of a network for web media distribution;

FIG. 2 shows a representative schematic diagram of data acquisition from web media within the network shown in FIG. 1;

FIG. 3 shows a further representative schematic diagram of data acquisition from web media within a network similar to that shown in FIG. 1;

FIG. 4 shows a schematic diagram of a media player with spectrum analysis diagnostics, associated with a web media as shown in any of the above figures; and

FIG. 5 shows a representative schematic diagram of data acquisition from web media as shown in any of FIGS. 1-3, utilising spectrum analysis diagnostics as shown in FIG. 4.

### DETAILED DESCRIPTION OF THE DRAWINGS

FIG. 1 illustrates a system overview of a network for distributing web media and determining digital media audibility according to the present invention. As shown in FIG. 1, the network comprises a user terminal 10 supporting a web browser 20. The user terminal 10 may take the form of any electronic device which is capable of running a web browser. In some examples, instead of a web browser, other types of interface through which web-based media may be obtained and made available may be used. In some examples, the user terminal 10 may be a desktop computer or PC.

In some examples, the user terminal 10 may be a portable or mobile device with a wired or wireless data connection. In some examples, the user terminal 10 may be a tablet computing device, a netbook, a laptop or a mobile phone capable of running a web browser. In examples where a web browser is used, the web browser 20 may, for example, comprise one of the following web browsers; Google Chrome™, Mozilla Firefox™, Internet Explorer™ or Safari™. This list is not intended to be exhaustive.

The user terminal 10 may comprise audio output means, or may be associated with audio output means, or both.

In use, the web browser 20 may be operated to access web pages. Some web pages may be designed to enable media to be played. In some examples, the media may be in the form of a video with associated audio or in the form of standalone audio content. In some examples the media may in the form of Pre-Roll audio that is delivered before further content is delivered. In some examples, the media may take the form of digital audio or rich media. In some examples, the media may be interactive. In some examples media is presented to or played on web pages using one or more media players. In some examples the media players may be a display list object, for example a sprite or a movie player, playing media supplied by a streaming channel. In some examples the diplay list object may be a NetStream object playing media supplied by a NetStream.

The media, for example an advertisement 40, may be distributed through a number of different servers before it is delivered to the web browser 20. The distribution of media, and particularly video media such as advertisements, can be considered a marketplace of selling and re-selling of media publications. In some examples of this marketplace, the audibility of media presented to a user can be subject to a number of audio controls, this may include for example, without limitation: creative-embedded audio controls managed by an ad unit/player; player-embedded audio controls provided by a publisher or network; and site-embedded audio controls provided for example by a network. Media players or streaming channels may be associated with the different parties within this marketplace.

In an exemplary arrangement, an advertiser will make an agreement with a publisher or network partner to publish media in the form of an advertisement a fixed number of times. To fulfil this agreement the publisher or network partner will arrange for distribution of the media from an advertising server 70. The publisher or network partner will seek to publish the advertisement to a number of user terminals, in order to fulfil the agreement. If the original publisher or network partner is unable to fulfil the agreement themselves, for whatever reason, the publisher or network partner may arrange for the further distribution of the media with a second publisher or network partner in order to fulfil the original agreement. This may then continue with the second publisher or network partner arranging for further distribution by a third publisher or network partner if the second publisher or network partner is unable to fulfil their arrangement, and so on. In the present application use of the terms “publisher” or “network partner” encompasses any or all of the publishers or network partners in this and similar scenarios.

The advertising server 70 may be a server, such as a web server, that operates to store media such as advertisements. Such media may be delivered to the user terminal 10 when a user visits a particular web page or website. In addition, advertising servers may also act to target particular media to particular users depending upon a set of rules. Therefore, a specific media, such as a particular advertisement 40, may have been placed on a plurality of different advertising servers. However, each instance of the specific media being published to a particular user terminal 10 will have originated in a single one of the advertising servers, being supplied through one or more servers of one or more publishers or network partners such as network partner server 60 forming a chain between the source advertising server 70 and the user terminal 10. Each advertisement 40 receives media from a publisher when a web page is loaded. In the present application use of the term “advertiser” encompasses any or all of these scenarios.

FIG. 2 shows a representative schematic diagram of data acquisition from web media within the network shown in FIG. 1. FIG. 2 can be considered to show an advertisement call process. The publisher operates a web page or website which is accessed by the user terminal 10 within the web browser 20. To access the media on the publisher's web site the user terminal 10 utilises a media player, here referred to as the user media player or terminal media player 30. To play digital audio media, such as the advertisement 40, the terminal media player 30 of the user terminal 10 sends a call, shown as arrow 36, to a network partner media player 65 of the network partner server 60, and the network partner server 60 in turn sends a call, shown as arrow 66, to an advertiser media player 75 of the advertising server 70 in order to play the media from the advertising server 70 through the user terminal 10. In some examples one or more of the media players may play media supplied by a streaming channel. In some examples one or more of the media players may comprise a NetStream object playing media supplied by a NetStream.

FIG. 3 shows a further representative schematic diagram of data acquisition from web media, where there is a further network partner server 50 of a further network partner between the advertising server 70 and the user terminal 10. In some embodiments there may be a greater number of network partners.

The resultant sound level (RSL) of the media played or provided to a user interacting with or using the user terminal 10, is a combination of: an audio level 77 (ALAS) of the advertiser media player; an audio level 67 and a possible audio level 57 (ALNP) which may be associated with one or more possible network partner media players 65 and 55; an audio level 37 (ALUS) of the terminal media player 30; the instantaneous sound level (ISL) associated with the terminal media player 30; and the volume setting (VSUT) on the user terminal itself. In some examples there may be more than one ALNP, with each ALNP associated with a different network partner media player. As discussed above, in some examples one or more of the media players may comprise a NetStream object playing media supplied by a NetStream.

Therefore, the resultant sound level RSL is a function of these:

RSL=fn(ALAS,ALNP,ALUS,ISL,VSUT) [1]

The volume or effective volume, termed above as instantaneous sound level (ISL), associated with the user terminal media player 30 is identified above as a factor in the resultant sound level, because different user media players may be set up differently with respect to the frequencies over which sound is output. Audio levels are perceived differently across different frequencies, and accordingly this needs to be accounted for during qualifying or quantifying sound audibility to a user.

For example, assigning each audio level or volume setting as a percentage value with a maximum of 100% and a minimum of 0%, then if the function of equation [1] was through multiplication of terms, then for ALAS, ALNP, ALUS, ISL, and VSUT all having a value of 50%, the RSL would be approximately 3%. At such a low RSL the final audio output may be inaudible to the user. Therefore, audio levels may be set to higher levels to improve audibility. In some examples the function of equation [1] is through convolution. In some examples the function of equation [1] is through addition. In some examples the function of equation [1] is through multiplication and/or convolution and/or addition. In some examples the function of equation [1] is through a different factor known in the art.

However, in a second example the same RSL of approximately 3% could be obtained when ALAS, ALUS, ISL, and VSUT all have values of 90% whilst the audio level associated with a network partner media player (ALNP) was set at approximately 5%.

Similarly, if any or all of the audio levels or volumes are set to mute or at very low levels, whilst the remaining levels are all set to 100%, the RSL could be zero or very nearly zero resulting in audio output that may be inaudible to the user.

However, it can be difficult to determine audio levels of specific systems or functions relating to data acquisition from web media. For example, it can be difficult to determine the audio levels associated with a network partner media player.

In some examples one or all of the network partner media players 65 and 55 may run from the user terminal 10. In some examples one or all of the network partner media players 65 and 55 may run from a platform operated by the network partners 60 and 50.

In some examples the advertiser media player 75 may run from the user terminal 10. In some examples the advertiser media player 75 may run from a platform operated by the advertiser such as from the ad server 70.

As shown in FIG. 1, in the illustrated network an analytics monitoring engine 90 is provided. The analytics monitoring engine 90 is used to determine the volume setting (VSUT) on the user terminal 10. The analytics monitoring engine 90 polls the advertiser media player 75 to determine the audio level 77 (ALAS). The analytics monitoring engine 90 similarly polls the user terminal media player 30 to determine the audio level 37 (ALUS).

In the illustrated example the analytics monitoring engine 90 runs on the user terminal 10. In some other examples the analytics monitoring engine 90 may run on an electronic or computing device external to the user terminal 10. This may be the case, for example, where the user terminal 10 is a device such as a mobile phone that may have limited processing capability, where the analytics monitoring engine 90 can be run on an external electronic or computing device in communication with the user terminal 10.

In some examples the analytics monitoring engine 90 runs on a platform operated by a network partner, such as the network partners servers 60 or 50. In some examples the analytics monitoring engine 90 runs on a platform operated by the advertiser, such as the advertising server 70.

It is possible to integrate messaging points within the media data so that when particular events occur it is possible to perform calculations or transmit data to external devices such as servers. In examples where the media is provided using one or more media players this may be done by embedding functionality in the form of software code embedded in the media player, such as, without limitation, the use of Action Script within an Adobe™ Flash™ NetStream. In examples where the media is provided using one or more NetStreams this may be done by integrating the message points with the NetStream object. The analytics monitoring engine 90 makes use of this functionality to poll the advertising server media player 75 and/or the user media player 30 to determine the audio level 77 and/or audio level 37 respectively. In some examples audio may be coming from an HTML5 <video> or <audio> element, in which case a Javascript Video Tag Element may be used to report the required audio levels. From these examples the person skilled in the art will clearly appreciate how these audio levels can be determined for other media formats.

FIG. 4 shows a schematic diagram of the user media player 30 on the user terminal 10 operating with spectrum analysis diagnostics. The spectrum analysis diagnostics have been used to provide a sound spectrum 35 associated with specific media playing at a specific time. The sound spectrum 35 shows the amplitude of sound at different frequency or wavelength bands. The sound spectrum 35 is the output of the audio from the user terminal media player 30 that has been subjected to a Fast Fourier Transform (FFT).

In some examples, an inverse FFT is obtained of the sound spectrum 35, which provides a single numerical value, the root of which can be used to provide a measure of the instantaneous sound level (ISL). In other examples an inverse of a transformed sound spectrum 35 is used to provide a measure of the ISL.

In some examples the sound spectrum has not passed through an FFT before being output from the user terminal media player 30. However, from the above example the person skilled in the art will understand that there are other methods by which a measure of the instantaneous sound level (ISL) can be provided in such situations, and those methods can be applied here in replacement of the method described above.

Referring back to equation [1], at an instantaneous point in time the RSL can be a function of one unknown, (ALNP) the audio levels 67 and 57 associated with a number of network partner media players 65 and 55, whist all other audio levels or volumes can be determined as discussed above.

Referring to FIG. 5, sound monitoring equipment 80 may be used to quantify or qualify the sound output from the user terminal 10, and any related audio equipment. The sound monitoring equipment is used to determine the RSL. Sound monitoring equipment 80 can be used to provide a percentage level of audibility thereby quantifying the RSL.

In some examples sound monitoring equipment uses a human-in-the-loop to determine the RSL, where the human-in-the-loop, from the sound output they hear, provides a quantified/qualified measure of the sound output to provide a determined RSL.

In some examples the RSL is determined fully autonomously using automated sound monitoring equipment 80.

From the above discussion, referring back to equation [1], it will be understood that ALNP, the audio level associated with a network partner media player can be determined.

In some examples the audio levels associated with a number of network partner media players can be determined.

FIG. 5 shows a schematic diagram of the user terminal media player 30 on the user terminal 10 operating with spectrum analysis diagnostics. As digital audio media, such as the advertisement 40, is played on the user terminal 10, sound monitoring equipment 80 is used to provide a time history RSL through the duration of the digital audio media placement. The RSL is determined as the audio media plays.

In one example training data can be generated and provided to the analytics monitoring engine 90 in order to train the analytics monitoring engine 90. This training may be used to arrive at values for parameters of a model which can then be used by the analytics monitoring engine 90 to determine audio levels or volumes as discussed above.

During this training process the following can be obtained: training resultant sound level (RSL_{T}); the training audio level of the advertiser media player (ALAS_{T}); the training audio levels associated with a number of network partner media players (ALNP_{T}); the training audio level of the user media player (ALUS_{T}); the training instantaneous sound level associated with the user media player (ISL_{T}); and the training volume setting on the user terminal itself (VSUT_{T}).

Accordingly, a model can be built up over a variable that may include a matrix of different digital audio media, different user media players, different publishers, and different network partners.

In some examples a model is built up over a matrix where one or more of: digital audio media, user media players, publisher, and network partner are fixed whilst the others vary over the model generation.

In some examples a model is built up where any or all of the above matrices are obtained through different user terminals.

In some examples a model is built up using synthetically generated or simulated audio media, user media players, publisher media players, and/or network partner media players.

In some examples a single model is built up of all the possible models combined.

Therefore, a model can be built across some dimension or parameter such as one, some or all of: a publisher; an advertising server media player; a network partner media player; a media player; a user terminal media player and a user terminal. The model can then be used to determine placement audibility across one, some or all of this parameter space. The model can also be used to provide a scoring factor for the placement audibility across this parameter space.

As discussed previously, in some examples one or more of the media players may be, or comprise, NetStream objects playing media supplied by NetStreams. Further, one or more of the media players may be media players embedded in other media players.

The model forms a part of the process for determining the audibility of digital audio media, where as discussed above a number of variables are used and stored for the model. As discussed above, the variables are calibrated and optimised based upon a set of training data.

In some embodiments, the model utilises a linear regression model. While the disclosed example uses Generalised Linear Regression, any suitable regression analysis may be used, for example, without limitation, one or more of, Ordinary Least Squares, Instrumental Variables, and Ridge Regression.

In some embodiments the model uses the variable determination analyses discussed above in relation to training data determined, with the different variables used in the linear regression model including some or all of the training data: resultant sound level (RSL_{T}); the audio level (ALAS_{T}) of the advertiser media player; the audio level (ALNP_{T}) associated with network partner media players; the audio level (ALUS_{T}) of the user media player; the instantaneous sound level (ISL_{T}) associated with the user media player; and the volume setting (VSUT_{T}) on the user terminal itself.

Therefore there are many logistic regression coefficients which may be used in the linear regression model:

RSL_{T} The experimentally determined resultant sound level.
ALAS_{T} The training audio level of the advertiser media player.
ALNP_{T} The training audio level of network partner media players.
ALUS_{T} The training audio level of the user media player.
ISL_{T} The training instantaneous sound level.
VSUT_{T} The training volume setting on the user terminal itself

The model is used to obtain an estimated value for the audibility AUD associated with a media placement, that provides information on the audibility of the media placement.

AUD=fn(ALAS,ALUS,ISL,VSUT,RSL_{T},ALAS_{T},ALNP_{T},ALUS_{T},ISL_{T},VSUT_{T}) [2]

In some examples the audibility is a function of a subset of these variables and training date parameter sets.

In some examples there may be more than one ALNP_{T}, with each ALNP_{T} associated with a different network partner media player.

As discussed above process of determining the logistic regression coefficients is through an empirical process by analysis of data representative of audio media played across a range of circumstances, whilst through a training process the audibility is externally measured or determined, to provide a qualitative or quantitate measure of audibility.

An advantage of utilising the above approach based on a number of variables utilising the raw data is that the data may be strongly linked to the processing performance of the user's device. The variation of system performance between users may be accounted for by utilising the regression model.

Therefore, in use data transmitted from the user terminal 10 may be sent to the analytics monitoring engine 90, running on the user terminal 10 or on an external server 95. The model runs as part of the analytics monitoring engine 90.

In some examples the analytics monitoring engine 90 is separate to the model.

The model operates to receive data from the user terminal 10 which is running the media within the web browser 20 in order to determine whether the audio media is audible in the browser 20. It may be advantageous to perform the processing remotely from the user terminal 10 since the user device providing the user terminal 10 may have limited processing resources. This is particularly relevant to mobile devices which have may have relatively limited processing resources.

In some examples the model may run on an external server. This remote server may comprise one or more pieces of server hardware. In some examples, the server hardware may perform operations on the data in parallel. In some examples, the model may be implemented in software which executes on the remote server. In some examples the model may operate across multiple pieces of hardware so as to share the processing. In some examples, the remote server may be configured to receive data from one or more terminals simultaneously.

The analytics monitoring engine 90 and model, when running on the user terminal 10, may similarly apply or utilise parallel processing, operate in software or firmware.

As will be discussed later the model is built from training data relating to the playing of digital audio media via an internet connection. The model is then used to provide information on real data relating to the playing of digital audio media via an internet connection. The output from the model is used to provide an estimated value associated with digital audio media played via an internet connection. This is provided through determining an associated audibility of media played via an internet connection. The output of the model can be used to indicate a probability that the media loaded by and displayed through a web browser is audible, from which a value can be assigned to the media placement or impression. The media under consideration could range from a single placement to a whole range of media associated with an advertising campaign.

In some examples, the step of finding the logistic regression coefficients may be performed after each particular impression or placement so that the regression model is regularly updated. However, this process is processor-intensive since, in practice, large numbers of impressions and placements occur each day. Therefore, in some examples the process of updating the regression coefficients in order to calibrate the model may be “batched” so that the calibration occurs periodically by preparing a set of training data. For example, the calibration process may occur daily, weekly, bi-weekly or monthly. The calibration process may be performed off-line or on separate hardware so as to not impact functionality.

As discussed previously it can be important to determine, in relation to an advertising campaign, whether the audibility of audio media has varied between the beginning and end of the placement.

Therefore, there is further provided a means of scoring the overall audibility (AUD_SCORE) across a number of placements, using a number of variables, in order to valuate potentially audible media. This is discussed below:
AVG_{SS} The average of ALUS at the start of the media across the placements
AVG_{SE} The average of ALUS at the end of the media across the placements
NUM The number of placements
AUD The audibility as determined from the model discussed above. This could relate to one, some or all of: a publisher; advertiser; network partner; media player; media type or specific media placements; depending upon the model configuration as discussed previously.
AVG_{LEN} The average length of the media across the placements

The overall audibility score is then:

AUD_SCORE=fn(AVG_{SS},AVG_{SE},NUM,AUD) [3]

In some examples the overall audibility score is calculated as

$${AUD}_{SCORE} = {( \frac{\sqrt{{AVG}_{SS}} + 2 \sqrt{{SND}_{EI}}}{3} )}^{2} \times time factor \qquad [ 4 ]$$

Where SND_{El} is an indicator that serves to weight the shift of sound that a user is making on the external sound volume. For example a negative shift would indicate that the user has reduced the volume. SND_{El} is given by:

$${SND}_{EI} = ( MAX ( 0 , {AVG}_{SE} ) + \frac{3}{2} MIN ( 0 , {AVG}_{SE} - {AVG}_{SS} ) ) \times \frac{AUD}{NUM} \qquad [ 5 ]$$

And where, time factor is a factor that serves to minimize the low number of samples that will come from a high bounce rate. Therefore, if very few people listen to more than a few seconds of an advertisement that is significantly longer than this, time factor serves to minimise the contribution to the overall audibility score from this listening experience. The time factor is given by:

$$time factor = 1 - \frac{1}{1 + \frac{1}{5} {AVG}_{LEN}^{2}} \qquad [ 6 ]$$

The above determined specific functional representation of the audibility score is a particular example of a representation of the audibility score. The person skilled in the art will appreciate from the above teaching that the discussed parameter space may otherwise be configured to determine an audibility score metric.

The values of the factors in equations 4 to 6 are examples only. These values have been determined experimentally to provide good results. However, there may be other values which will also provide useful results.

Those skilled in the art will appreciate that while the foregoing has described what are considered to be the best mode and, where appropriate, other modes of performing the invention, the invention should not be limited to specific apparatus configurations or method steps disclosed in this description of the preferred embodiment. It is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings. Those skilled in the art will recognize that the invention has a broad range of applications, and that the embodiments may take a wide range of modifications without departing from the inventive concept as defined in the appended claims.

1. A method of determining the audio level of a network partner media player, wherein;
when media playing on a terminal media player running on a terminal originates from an external media source, the method comprises:
obtaining activity information from the terminal;
obtaining activity information from the terminal media player;
obtaining activity information from an external source media player associated with the external media source; and
analysing:
the activity information from the terminal;
the activity information from the terminal media player;
the activity information from the external media source media player, whereby
the audio level of the network partner media player is determined.

2. A method according to claim 1, wherein the terminal media player runs on a web page in a web browser on the terminal.

3. A method according to claim 1, wherein the external media source is an advertiing server.

4. A method according to claim 1, wherein the activity information from the terminal comprises a determined sound level.

5. A method according to claim 1, wherein the activity information from the terminal comprises the terminal volume setting.

6. A method according to claim 1, wherein the activity information from the terminal media player comprises the audio level of the terminal media player.

7. A method according to claim 6, wherein the terminal media player is polled to determine the audio level.

8. A method according to claim 7, wherein the terminal media player comprises Flash™/Actionscript.

9. A method according to claim 8, wherein the polling comprises using global mixer volume.

10. A method according to claim 7, wherein the terminal media player comprises a HTML5 <video> element.

11. A method according to claim 7, wherein the terminal media player comprises a HTML5 <audio> element.

12. A method according to claim 10, wherein polling comprises using a Javascript Video Tag Element.

13. A method according to claim 1, wherein the activity information of the terminal media player comprises information relating to the frequency spectrum of audio output from the terminal media player.

14. A method according to claim 13, wherein information relating to the frequency spectrum of audio output from the terminal media player comprises determining the audio amplitude at different frequencies of the frequency spectrum.

15. A method according to claim 14, further comprising combining the audio amplitude at different frequencies.

16. A method according to claim 14, wherein determining the audio amplitude at different frequencies comprises determining an inverse of a transformed frequency spectrum.

17. A method according to claim 1, wherein the activity information of the external media source media player comprises the audio level.

18. A method according to claim 17, wherein the external media source media player is polled to determine the audio level.

19. A method according to claim 18, wherein the external media source media player comprises Flash™/Actionscript.

20. A method according to claim 19, wherein the polling comprises using global mixer volume.

21. A method according to claim 18, wherein the terminal media player comprises a HTML5 <video> element.

22. A method according to claim 18, wherein the user media player comprises a HTML5 <audio> element.

23. A method according to claim 21, wherein the polling comprises using a Javascript Video Tag Element.

24. A method according to claim 4, wherein the sound level is determined using sound monitoring equipment.

25. A method according to claim 4, wherein:
the activity information from the terminal comprises information relating to the terminal volume setting;
the activity information from the terminal media player comprises the audio level of the terminal media player;
the activity information of the terminal media player comprises the audio output from the terminal media player;
the activity information of the external media source media player comprises the audio level; and
analysing the activity information from the terminal, the activity information from the terminal media player, and the activity information from the external media source media player comprises combining any two or more of:
the terminal volume setting;
the audio level of the terminal media player;
the audio output from the terminal media player; and
the audio level of the external media source media player,
wherein the resultant value is taken from the determined sound level from the terminal.

26. A method according to claim 25, wherein the combining comprises multiplication.

27. A method according to claim 25, wherein the combining comprises convolution.

28. A method according to claim 25, wherein the combining comprises addition.

29. A method according to claim 25, wherein taking the resultant value from the determined sound level comprises division.

30. A method according to claim 25, wherein taking the resultant value from the determined sound level comprises de-convolution.

31. A method according to claim 25, wherein taking the resultant value from the determined sound level comprises subtraction.

32. A method according to claim 1, wherein the media is digital media.

33. A method according to claim 32, wherein the media is digital audio media.

34. A method according to claim 32, wherein the media is an advertisement.

35. Computer apparatus arranged to determine the volume output of a network partner media player, the apparatus comprising:
an interface configured to receive activity information from code running on the terminal; and
computer code operable, when executed, to carry out the method of claim 1.

36. A method of determining whether media playing on a terminal media player running on a terminal is audible, wherein the media originates from an external media source, the method comprising:
monitoring and analysing activity information associated with media when playing on the terminal to determine whether the media is audible.

37. A method according to claim 36, wherein the terminal media player runs on a web page in a web browser on the terminal.

38. A method according to claim 36, wherein the external media source is an advertising server and the media is advertising.

39. A method according to claim 36, wherein activity information associated with media when playing on the terminal comprises information relating to the terminal volume setting.

40. A method according to claim 36, wherein the activity information associated with media when playing on the terminal comprises information relating to the activity of the terminal media player.

41. A method according to claim 40, wherein the terminal media player calls and runs a media player associated with the external media source.

42. A method according to claim 41, wherein the activity information associated with media when playing on the terminal comprises information relating to the activity of the external media source media player.

43. A method according to claim 36, wherein the media originating from the external media source is provided to the terminal via a network partner.

44. A method according to claim 43, wherein the terminal media player calls and runs a network partner media player, wherein the network partner media player calls and runs the external media source media player.

45. A method according to claim 44, wherein, the activity information associated with media when playing on the terminal comprises information relating to the activity of the network partner media player.

46. A method according to claim 36, wherein the obtained activity information is input into a model; and
wherein the model provides an estimation of whether the media is audible based upon the input activity information.

47. A method according to claim 46, wherein the model is a numerical model.

48. A method according to claim 47, wherein the numerical model comprises a probabilistic model.

49. A method according to claim 47, wherein the numerical model comprises a regression analysis.

50. A method according to claim 47, wherein the coefficients of the numerical model are determined using training activity information.

51. A method according to claim 40, wherein the activity of the terminal media player comprises the audio level of the terminal media player.

52. A method according to claim 40, wherein the information relating to the activity of the terminal media player comprises information relating to the frequency spectrum of audio output from the terminal media player.

53. A method according to claim 52, wherein information relating to the frequency spectrum of audio output from the terminal media player comprises determining the audio amplitude at different frequencies of the frequency spectrum.

54. A method according to claim 53, comprising combining the audio amplitude at different frequencies.

55. A method according to claim 53, comprising determining an inverse of a transformed frequency spectrum.

56. A method according to claim 42, wherein the activity of the external media source media player comprises the audio level.

57. A method according to claim 51, wherein the media player is polled to determine the audio level.

58. A method according to claim 57, wherein the media player comprises Flash/Actionscript.

59. A method according to claim 58, wherein polling comprises using global mixer volume.

60. A method according to claim 57, wherein the media player comprises a HTML5 <video> element.

61. A method according to claim 57, wherein the media player comprises a HTML5 <audio> element.

62. A method according to claim 60, wherein polling comprises using a Javascript Video Tag Element.

63. A method according to claim 36, wherein activity information from the user terminal comprises a determined sound level.

64. A method according to claim 63, wherein the sound level is determined using sound monitoring equipment.

65. A method according to claim 45, wherein the activity of the network partner media player comprises the volume output of the network partner media player determined using the method of claim 1.

66. A method according to claim 34, wherein the media is digital media.

67. A method according to claim 66, wherein the media is digital audio media.

68. A method according to claim 66, wherein the media is an advertisement.

69. Computer apparatus arranged to determine the volume associated with media playing on a web page in a web browser on a user terminal, the apparatus comprising:
an interface configured to receive activity information from code running on the user terminal;
computer code operable, when executed, to carry out the method of claim 34.
